(19) United States
(12) Patent Application Publication
(10) Pub. No.: US 2011/0056082 A1
(43) Pub. Date: Mar. 10, 2011

(54) ELECTRIC SHEARS

(75) Inventor: Fangjie Nie, Nanjing (CN)

(73) Assignee: CHERVON LIMITED, Wanchai (HK)

(21) Appl. No.: 12/874,290

(22) Filed: Sep. 2, 2010

(30) Foreign Application Priority Data
Sep. 8, 2009 (CN) 200920232701.2

(51) Int. Cl. B26B 15/00

(52) U.S. Cl. 30/228

(57) ABSTRACT

Electric shears include a housing, a motor mounted within the housing, at least one blade driven by the motor, and a trigger mounted on the housing for controlling the motor. The electric shears further include a controller for controlling the motor and a mode-selecting switch mounted on the housing and connected to the controller. The controller responds to the mode-selecting switch and controls the electric shears to switch between at least two kinds of operation modes. Since the electric shears has at least two kinds of operation modes, more functions and a broader range of applications can be achieved.

### RELATED APPLICATION INFORMATION

This application claims the benefit of CN 200920232701.2, filed on Sep. 8, 2009, the disclosure of which is incorporated herein by reference in its entirety.

### BACKGROUND

As one category of electric tools, electric shears include shears for shearing thick fibers, such as carpets, shears for cutting cables, shears for lopping off branches, and the like. For example, electric shears for lopping off branches are commonly used as a tool during gardening to keep trees or shrubs a beautiful shape. Generally, such electric shears comprise a fixed blade and a movable blade. A cutting mouth is defined between the two blades. The movable blade can swing in a reciprocating motion driven by a motor to make the cutting mouth opened or closed to thereby cut off branches positioned within the cutting mouth.

According to the modes of motion, current electric shears may be generally divided into two types: a continuous motion type and a single triggering-motion type. The so-called “continuous motion type” means that the movable blade may implement a continuous reciprocating motion after the switch trigger of the electric shears is pressed, so that the cutting mouth is enabled to be opened and closed continuously until such motion is stopped when the trigger is released. The so-called “single triggering-motion type” means that the movable blade may swing toward the fixed blade to close the cutting mouth after the switch trigger of the electric shears is pressed and, when the switch trigger is released, the movable blade may move away from the fixed blade to open the cutting mouth. These two kinds of electric shears can be respectively adapted to different working conditions, that is, electric shears with continuous motion type are suitable for larger workloads where it is desired to prevent fatigue of the user caused by a need to press and release the trigger continually, while electric shears with single triggering-motion type are suitable for smaller workload because the motions of the blades can be absolutely controlled by the user. In addition, electric shears of the single triggering-motion type are relatively safe for users.

However, existing electric shears only have one kind of operation mode with a single function. Thus, it existing electric shears can not be adapted to all types of working conditions and also can not meet the demands of the users.

### SUMMARY

The following describes improved electric shears that have at least two kinds of operation modes and that are therefore suitable for different working conditions.

The electric shears disclosed hereinafter particularly comprise a housing, a motor mounted within the housing, at least one blade driven by the motor and a trigger mounted on the housing for controlling the motor. The electric shears further comprise a controller for controlling the motor and a mode-selecting switch mounted on the housing and connected to the controller. The controller may respond to the mode-selecting switch to control the electric shears to switch between at least two operation modes. Because the described electric shears have at least two operation modes, the functions thereof can be further improved and the application range thereof may be broader. As a result, a user will only need to purchase one pair of electric shears to have access to various functions and thus costs are saved.

Preferably, the controller of the electric shears comprises a SCM in which many kinds of programs corresponding to the operation modes respectively are provided. When the electric shears are operated in one of the operation modes, the corresponding program will be called. Therefore, although the electric shears have various operation modes, there is no increase in the size, the weight, and the like.

Preferably, the mode-selecting switch of the electric shears has a plurality of positions each of which corresponds to an operation mode. During operation, the user can adjust the mode-selecting switch to the corresponding position according to an operation requirement and, accordingly, the desirable operation mode can be obtained. Thus, the electric shears of the present invention also have the advantage of easy and convenient operation.

### BRIEF DESCRIPTION OF THE DRAWINGS

The electric shears will be further described in detail hereinafter in combination with the accompanying drawings, wherein:

FIG. 1 is a schematic view of an embodiment of electric shears constructed according to the description that follows;

FIG. 2 is a circuit schematic diagram of the electric shears of FIG. 1; and

FIG. 3 is a controlling flow chart of the electric shears of FIG. 1.

### DETAIL DESCRIPTION

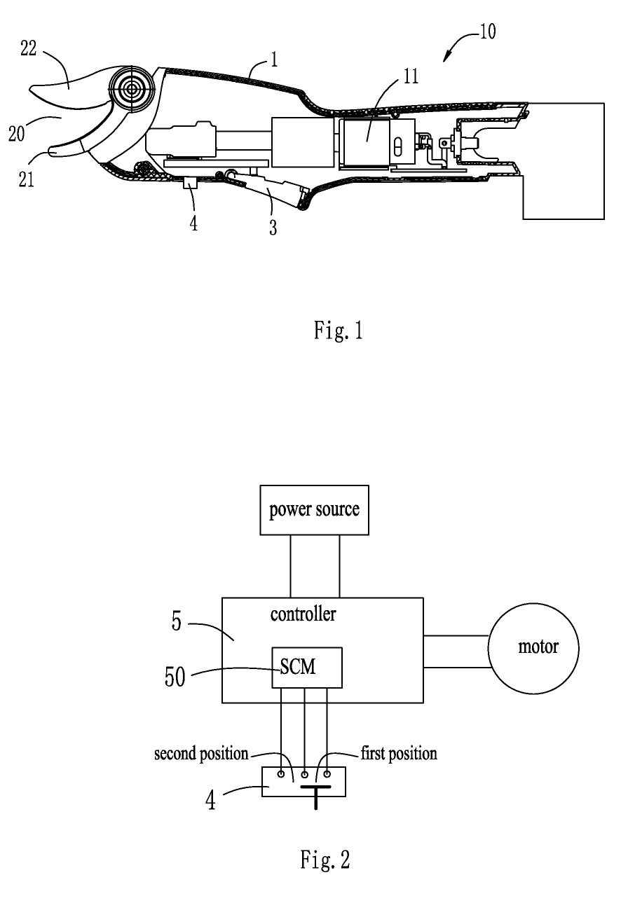

Turning to FIG. 1 and by way of example only, a pair of electrical shears 10 for use in lopping off branches is illustrated and comprises a housing 1 and a motor 11 mounted within the housing 1. A fixed blade 21 is fixedly mounted on the housing 1 and a movable blade 22 is driven by the motor 11 to swing in a reciprocating motion so that a cutting mouth is defined between the fixed blade 21 and the movable blade 22. The reciprocating swing of the movable blade 22 makes the cutting mouth 20 opened or closed so as to shear off the branches within the cutting mouth 20. A trigger 3 and a mode-selecting switch 4 are further mounted on the housing 1, wherein, the trigger 3 is used for controlling the motor and the mode-selecting switch 4 is provided for the user to select the operation mode of the electric shears 10.

Turning to FIG. 2, illustrated is a circuit schematic diagram of the electric shears 10. A controller 5 is mounted in the housing 1 and connected to the power source, the motor, and the mode-selecting switch. The mode-selecting switch 4 has a first position and a second position. The controller 5 includes a SCM 50 or other suitable processing device in which a continuous-motion program and a single triggering-motion program are provided. The mode-selecting switch 4 is electrically connected to the SCM 50.

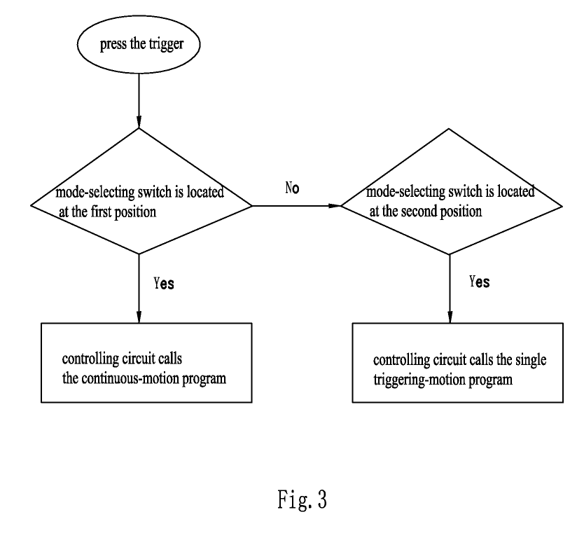

As shown in FIG. 3, when the mode-selecting switch 4 is triggered and located in a first position, the electric shears 10 may be operated in the first operation mode and the continuous-motion program of the SCM is called. At this time, the movable blade 22 of the electric shears 10 may continuously swing in a reciprocating motion to make the cutting mouth 20 opened and closed continuously. When the mode-selecting switch 4 is triggered and located in the second position, the electric shears 10 may be operated in the second operation mode and the single triggering-motion program is called. At this time, the movable blade 22 of the electric shears 10 is closed if the trigger 3 is pressed or opened if the trigger 3 is released. Thus, the user can select the operation mode of the electric shears 10 according to their requirements.

In other embodiments, the electric shears can also be incorporated with other operation modes. Those skilled in the art can devise the electric shears with three or more kinds of operation modes according to the principle of the present invention.

In another embodiment, the electric shears further includes a plurality of the mode-switches, each of which corresponds to the operation mode of the electric shears. The user can press the corresponding mode-switch according to the desirable operation mode.

In another embodiment, the controller can comprise a plurality of SCMs, each of which is provided with one program for controlling the electric shears to implement one kind of motion mode.

The electric shears disclosed by the present invention is not limited by the above-mentioned contents and the structures shown in the drawings. For example, the shape of the electric shears and/or the positions of the trigger and the mode-selecting switch can be modified. Accordingly, any such modifications, changes, or substitutions to the shapes and positions of the illustrated and described components based on the spirit of this invention will be regarded as falling within the scope of the claims that follow.

What is claimed is:

1. A pair of electric shears, comprising:
a housing;
a motor mounted within the housing;
at least one blade associated with the housing and driven by the motor; and
a trigger mounted on the housing for controlling the motor;
wherein, the electric shears further comprise a controller for controlling the motor and a mode-selecting switch mounted on the housing and connected to the controller; and the controller is operable to respond to the mode-selecting switch and control the electric shears to switch the modes between at least two operation modes.

2. The electric shears of claim 1, wherein the mode-selecting switch includes at least two positions, the electric shears are operated in a first operation mode when the mode-selecting switch is in a first position and in a second operation mode when the mode-selecting switch is in a second position.

3. The electric shears of claim 2, wherein the blade continuously swings in a reciprocating motion in the first operation mode and, in the second operation mode, the blade swings toward a first direction when the trigger is pressed and toward an opposite second direction when the trigger is released.

4. The electric shears of claim 3, wherein the controller includes a SCM in which a first program corresponding to the first operation mode and a second program corresponding to the second operation mode are provided.

5. The electric shears of claim 4, wherein the first program of the SCM is called when the mode-selecting switch is located in the first position and the second program of the SCM is called when the mode-selecting switch is located in the second position.
